(19) United States
(12) Patent Application Publication
(10) Pub. No.: US 2006/0041628 A1
(43) Pub. Date: Feb. 23, 2006

(54) Electronic routing slips for inter-organizational electronic mail

(75) Inventor: Michael Muller, Medford, MA (US)

Correspondence Address: GUERIN & RODRIGUEZ, LLP, 5 MOUNT ROYAL AVENUE, MOUNT ROYAL OFFICE PARK, MARLBOROUGH, MA, 01752, US

(73) Assignee: International Business Machines Corporation, Armonk, NY (US)

(21) Appl. No.: 10/924,380

(22) Filed: Aug. 23, 2004

(51) Int. Cl. G06F 15/16

(52) U.S. Cl. 709/206

(57) ABSTRACT

A system and method for separating inter-organizational email from the intra-organizational processing of that email are described. An email message is received by an email client program executing at a client computing system. A route operation is selected for the email message. A routing slip is generated in response to the route operation. The routing slip includes an electronic representation of the email message and can be sent to other members of an organization bearing this representation. Each recipient of the routing slip can access the email message through the electronic representation. Information that becomes part of the routing slip remains separate from the contents of the email message. To reply to the email message, an unroute operation restores the email message from the routing slip. A reply to the email message can then be sent without any of the information in the routing slip appearing the reply.

### FIELD OF THE INVENTION

The invention relates generally to electronic mail. More particularly, the invention relates to a system and method for separating inter-organizational electronic mail from the intra-organizational processing of that electronic mail.

### BACKGROUND

In complex organizational message routing, people often attach instructions to a customer-originated electronic mail (email) message, for internal routing and handling by certain personnel within an organization. In some cases, these handling-and-routing instructions are private to the organization, and should not be divulged to the customer. In other cases, the eventual reply message is supposed to appear to have originated from the mailbox of the original recipient, even if other people worked on it. A common practice is to prepend the instructions within the body of the forwarded email message, where those instructions may inadvertently be sent back to the customer as part of a “reply with history” operation. This situation becomes more complicated if the request of the customer passes through the mailboxes of many people, Consequently, there may be a complex series of forwarding messages that are difficult to parse through and to remove before eventually sending a response back to the customer, with an appropriate (although simulated) return address.

Another problem occurs with record-keeping: typically, the message that is stored as a record of the communication with the customer is the same message that is actually sent to the customer. If the organization has successfully removed the routing-and-handling instructions, then the intra-organizational work-record of how the organization dealt with the customer's request may be lost.

### SUMMARY

In one aspect, the invention features a method for separating an email message from intra-organizational communications used to process that email message. A first email message is received by an email client program executing at a client computing system. A route operation is selected for the first email message. In response to selecting the route operation, a second email message is generated having therein an electronic representation of the first email message through which content of the first email message can be accessed by a viewer of the second email message.

In another aspect, the invention features a computing system, comprising a processor, memory, and an email client program stored in the memory and executed by the processor. The email client program receives a first email message and generates a second email message having therein an electronic representation of the first email message in response to a selection of a route operation for the first email message. Content of the first email message is accessible by a viewer of the second email message through the electronic representation.

In still another aspect, the invention features an apparatus for separating an email message from intra-organizational communications used to process that email message. The apparatus comprises means for receiving a first email message by an email client program executing at a client computing system, means for selecting a route operation for the first email message, and means for generating, in response to the selecting of the route operation, a second email message having therein an electronic representation of the first email message through which content of the first email message can be accessed by a viewer of the second email message.

In still another aspect, the invention features a computer program product for use with a computer system. The computer program product comprises a computer useable medium having embodied therein program code comprising program code for receiving a first email message by an email client program executing at a client computing system, program code for selecting a route operation for the first email message, and program code for generating, in response to the selecting of the route operation, a second email message having therein an electronic representation of the first email message through which content of the first email message can be accessed by a viewer of the second email message.

In yet another aspect, the invention features a computer data signal embodied in a carrier wave for use with a computer system having a display and capable of generating a user interface through which a user may interact with the computer system. The computer data signal comprises program code for receiving a first email message by an email client program executing at a client computing system, program code for selecting a route operation for the first email message, and program code for generating, in response to the selecting of the route operation, a second email message having therein an electronic representation of the first email message through which content of the first email message can be accessed by a viewer of the second email message.

### BRIEF DESCRIPTION OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a block diagram of an embodiment of a computer system including an email system of the present invention.

FIG. 2 is a flow diagram of an embodiment of processes for separating an email message from intra-organizational communications used to handle and route that email message.

FIG. 3 is a flow diagram of another embodiment of a process for separating an email message from intra-organizational communications used to process that email message.

### DETAILED DESCRIPTION

The present invention facilitates collaboration among members of an organization in handling and routing shared email messages. An increasing number of organizations are devising operational settings in which two or more persons collaborate on email messages. Examples of such settings include 1) executives and their assistants who share access to an emailbox; 2) shared emailboxes at schools and in human resource departments; 3) public executive email services, which allow members of the public to correspond with executives of an organization; and 4) email-based customer care centers, which permit customers to submit questions and requests to an organization. In such settings, organization members may collaborate by sharing access to email messages in the same emailbox or by handling email messages as they are routed through the organization.

When working with a shared email message, a member may need to send the email message to another member within the organization, with handling or routing instructions (or both). These handling and routing instructions are often considered internal (i.e., intra-organizational) communications, not intended for sharing with the originator of the email message, particularly if the originator is not a member of the organization. When the originator is not a member of the organization, the email message is also referred to herein as an inter-organizational email message. The present invention keeps the intra-organizational communications associated with an inter-organizational email message separate from that inter-organizational email message.

More specifically, the present invention features a new type of email message, referred to as a routing slip, which is associated with but remains distinct from an inter-organizational email message. The routing slip circulates among those members of the organization who are designated to handle the inter-organizational email message. Through the routing slip, each recipient can access the inter-organizational email message to review its contents. The originator and any subsequent recipients can write their comments, instructions, and the like to the routing slip, where such communications remain separate from and external to the inter-organizational email message. Thus, the routing slip makes the handling-and-routing instructions more socially communicative, allowing the organization to maintain a private communication medium and a record of the process by which the organization responded to the inter-organizational email message.

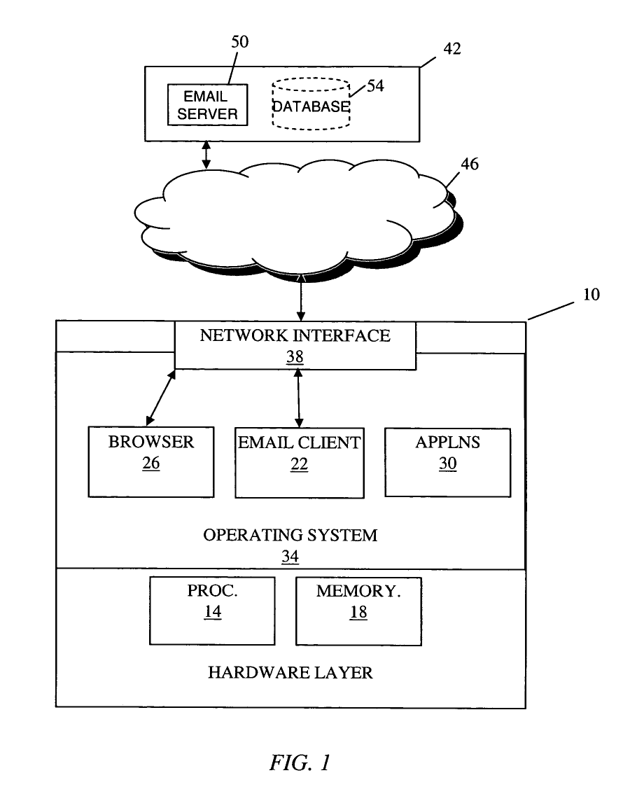

FIG. 1 shows an embodiment of a client computing system 10 constructed in accordance with the invention. In general, the client computing system 10 is a computing device having a processor 14, a user interface, a display screen, an input device (e.g., keyboard, a mouse, trackball, touch-pad, touch-screen, etc), and persistent storage 18 for storing data and software programs. Exemplary embodiments of the client computing system 10 include, but are not limited to, a personal computer (PC), a Macintosh computer, a workstation, laptop computer, a mainframe computer, a hand-held device such as a personal digital assistant (PDA) and a cellular phone, a network terminal, and an online gaming device such as Microsoft's XBOX™ or Sony's PLAYSTATION™. One software program stored in the persistent storage 18 is an email client program 22 of the invention. Other software programs can include browser software 26, e.g., MICROSOFT INTERNET EXPLORER™, and office applications 30, such as MICROSOFT WORD™. The email client program 22 and other programs 26, 30 run on an operating system 34. The operating system 34 of the client computing system 10 can be one of a variety of platforms including, but not limited to, WINDOWS 98, WINDOWS NT 4.0, WINDOWS XP, PALM OS, Macintosh, JAVA, LINUX, UNIX, and WINDOWS CE for windows-based terminals.

The client computing system 10 also includes a network interface 38 for communicating with a server 42 over a network 46. The server 42 includes an email server 50 and an optional internal-use-only database 54 for storing email messages in accordance with the principles of one embodiment of the invention. The email client program 22 communicates with an email server 50 over the network 46 to receive and transmit email messages.

The network 46 can be a local-area network (LAN), a metro-area network (MAN), or wide-area network (WAN), such as the Internet or World Wide Web. Users of the client computing system 10 can connect to the server 42 through one of a variety of connections, such as standard telephone lines, LAN or WAN links (e.g., T1, T3), broadband connections (Frame Relay, ATM), and wireless connections (e.g., 802.11(a), 802.11(b), 802.11(g)).

In an alternative embodiment, the client computing system 10 is any terminal (windows or non-windows based), or thin-client device operating according to a server-based computing model. In a server-based computing model, the execution of application programs occurs entirely on an application server (not shown), and the user interface, keystrokes, and mouse movements are transmitted over the network 46 to the client computing system 10. The user interface can be text driven (e.g., DOS) or graphically driven (e.g., Windows).

The email client program 22 of the invention can be any proprietary email client program or any commercially available email client program, such as Lotus NOTES™ and Microsoft OUTLOOK™, modified to support routing slips of the invention. As described above, a routing slip is a specific type of email message that is associated with an email message (e.g., an inter-organizational email message) received by the email client program 22.

The routing slip has conventional email message features and functionality: it resides in the same emailbox as other inter-organizational and intra-organizational email messages; its originator can send the routing slip to one or more intra-organization emailboxes; and each recipient can forward or reply to the routing slip, preferably with a history or record of any communications added to the routing slip by the members of the organization. A routing slip can also be tagged or flagged so that it cannot be transmitted externally (i.e., outside of the organization), whether advertently or inadvertently, to ensure that the intra-organizational communications added to the routing slip remain within the organization.

Each routing slip includes an actionable electronic representation of the email message with which that routing slip is associated. The actionable electronic representation can appear, for example, in the body of or in an attachment field of the routing slip. Actionable, as used herein, means that a user can activate, execute, or launch the representation with, for example, a mouse-click. Activating the electronic representation causes the content of the original email message to be displayed to the viewer. Any one of a variety of applications may execute to display the email message. Examples include the browser 26, an office application 30, or the email client program 22. The electronic representation accompanies the routing slip to whomever the routing slip is sent. Thus, the routing slip becomes a vehicle by which members of the organization can access the original email message (although the original email message itself may not circulate).

To support routing slips, the email client program 22 provides two operations: 1) a route operation; and 2) an unroute operation. Route operations are generally available for use with any email message in an emailbox (with an exception, in one embodiment, of email messages that have already been “routed” and “unrouted” as described below). Activating the route operation for a given email message generates a new routing slip in the emailbox, converts the original email message into another electronic format, and embeds an actionable electronic representation of the email message into the routing slip. An organization may customize the appearance of the routing slip, for example, so that the routing slip includes radio buttons or checkboxes for identifying, performing, and recording the performance of routine tasks. In one embodiment, the route operation also removes the original email message from the emailbox so that more than one routing slip cannot be generated for the same email message.

An Unroute operation recovers an original email message from the routing slip with which that original email message is associated. After the unroute operation completes, two email messages reside in the emailbox: 1) the “unrouted” routing slip; and 2) the “unrouted” email message.

The unrouted routing slip provides a record of the intra-organizational communications. An electronic representation of the original email message may remain in the routing slip after the unroute operation completes. Alternatively, the unroute operation can remove the electronic operation from the routing slip to ensure that more than one unroute operation cannot be performed on the same routing slip. For embodiments removing the electronic representation, information identifying the original email message can be included in the routing slip (e.g., as a result of the unroute operation) so that traceability remains between the unrouted routing slip and its associated email message.

The unrouted email message contains the content of the original email message and serves as the means by which the member of the organization can send a reply message to the sender of the original email message. None of the communications that become part of the routing slip appears in the unrouted email message unless deliberately added there by the member. The unrouted email message can be flagged so that a viewer can see that a reply has already been sent to the originator for this email message or so that a second route operation cannot be performed on an email message that has already been routed and unrouted.

The route and unroute operations described above are selectable items that can appear in a drop-down menu or as a graphical icon in a toolbar (or both) within a routing slip, email message, or emailbox. Each icon (for example) for a given operation may appear “grey” when that particular operation is not available for a given email message or routing slip. For example, the unroute operation is not applicable for any type of email message other than a routing slip. As another example, the route operation may not be available for an email message that has already been routed, i.e., associated with a routing slip.

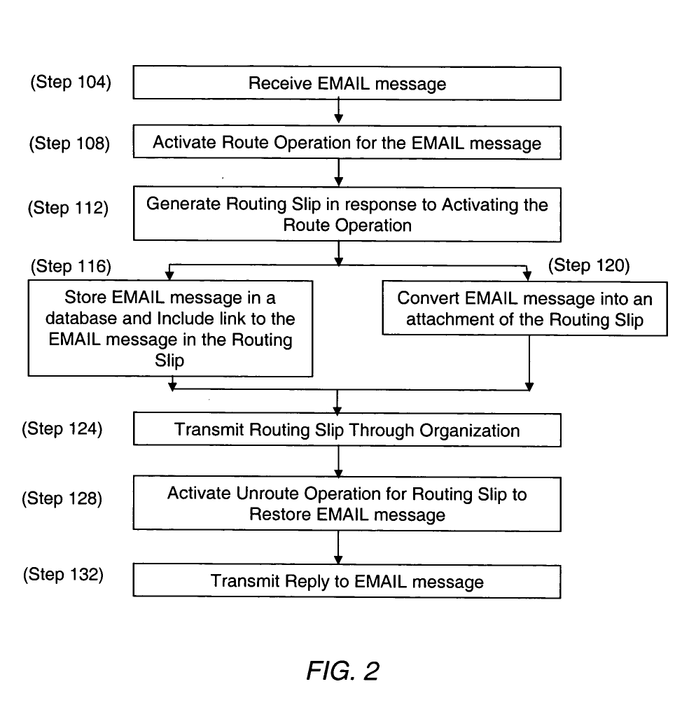

FIG. 2 shows embodiments of processes for internally handling and routing an email message within an organization such that intra-organizational communications remain separate from the contents of the email message. At step 104, the client computing system 10 receives an email message (including any attachments). Consider, for example, that this email message is from a customer of the organization; namely, the email message is inter-organizational and is hereafter referred to as a customer email message. A member of the organization selects (step 108) a route operation for the customer email message.

Activating the route operation causes (step 112) generation of a routing slip that is associated with the customer email message. In one embodiment, the route operation converts (step 116) the customer email message into an electronic format (i.e., a record) suited for storing in the database 54 (FIG. 1). A link to the record is inserted into the routing slip. The link can be a pathname for accessing the record within the database 54. The link accompanies the routing slip to whomever the routing slip is sent, while the record corresponding to the customer email message resides within the database 54. Links may be indicated with an underline, a color contrast, or a border. This link is actionable in that a viewer of the routing slip can click on the link to view the customer email message. Alternatively, the viewer of the routing slip can execute a separate application program designed to access this database 54 and supply the pathname to the application to access the record.

In another embodiment, the customer email message is converted (step 120) into an attachment file that is attached to the routing slip. The attachment file accompanies the routing slip to whomever the routing slip is sent. To view the content of the customer email message, a recipient of the routing slip can double-click on the attachment file to cause the email client program 22, for example, to restore the customer email message for viewing. In yet another embodiment, an attachment file and a link are included in the routing slip.

The originator of the routing slip can then enter information in the body of the routing slip, e.g., provide handling instructions, and email (step 124) the routing slip to another member for further processing. The member receiving the routing slip can read the contents of the routing slip and view the contents of the customer email message. To view the contents of the customer email message entails a deliberate action on the part of the routing slip recipient (e.g., opening the attachment or clicking on the link to the mail message in the database). In the process of viewing the contents of the customer email message, the contents remain separate from the contents of the routing slip. The member receiving the routing slip can then add information to the body of the routing slip, and subsequently send the routing slip to yet another member of the organization or back to the routing slip originator using conventional email forward or reply-with-history operations on the routing slip. Such operations leave the contents of the customer email message unaffected. In this way, a record of who has seen the customer email message, what each receiving member wrote about it, and other internal communications (including potential internal-only attachments) may be accumulated in the routing slip, without appearing in the customer email message.

Preferably, each member can send the routing slip to only one other person (i.e., no multiple recipients, bcc recipients, or cc recipients). This limit on the number of concurrent recipients can prevent multiple routing slips associated with a single email message from circulating through an organization at any given moment and thus avoids the possibility of multiple replies being sent to the sender of the customer email message. Any number of recipients in sequence, however, can be called upon to review the routing slip and the customer email message. To further ensure that multiple routing slips for the same customer email message do not concurrently circulate through an organization, after the routing slip is emailed from one member to another member, any copy of the routing slip remaining at the sender's emailbox is deleted, moved to a special mailbox folder, or disabled for subsequent transmission.

Other embodiments can permit multiple simultaneous recipients of a routing slip. Such embodiments may require additional email capabilities, such as the merging of routing slips to capture potentially diverse forwarding or reply histories and internal organizational policies to avoid replying more than once to the customer email message.

When the time arrives to reply to the sender of the customer email message, the organization member who is replying executes an unroute operation. Depending upon the electronic format of the customer email message, the unroute operation restores the customer email message for viewing and any editing by the replying member. In one embodiment, the customer email message is retrieved from the database 54. In another embodiment, the customer email message is recovered from the attachment file attached to the routing slip. The replying member can then reply to the email message in any appropriate manner, with none of the routing slip communications becoming part of the reply email unless explicitly copied by the user from the routing slip and written into that reply email.

Upon completing the reply, the replying member may archive (a) the reply sent to the sender of the customer email, (b) the routing slip, with all of its attachments, reply-with-history comments, and the like, or (c) both. Thus, the organization can have a track record of what was sent to the customer, and a relatively complete track record of the internal work that was done to make that reply to the customer possible. The organization can use the database 54 as the archive (in those embodiments using the database 54). The replying member can add the routing slip (with the full history of activities) into that database 54 as an attachment or as a child-object of the saved customer email message and the saved reply. The archiving of customer email messages, replies, and routing slips enables organizations to track, reference, and summarize various activities based on the identity of a particular customer, receiving member, and replying member. Organizations can also perform analyses and generate reports, such as the timeliness of responses and current status of unanswered email messages, based on the ability to track activities.

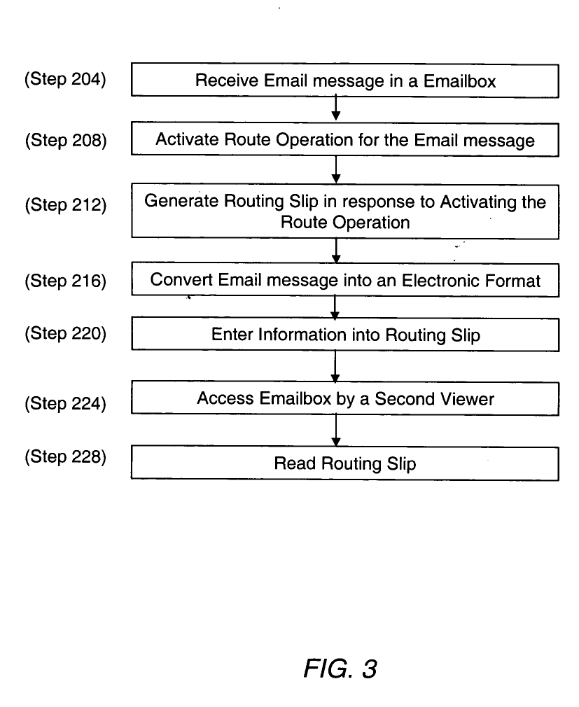

FIG. 3 shows another exemplary application of the present invention for keeping the contents of an inter-organizational email separate from any intra-organizational communications exchanged while handling that email. Consider for this example that two members of an organization share access to an emailbox: an assistant and an executive. The assistant provides an initial review of email messages that arrive at the emailbox to screen less important messages from important messages. In step 204, the emailbox of the executive receives an email message (e.g., from a customer of the organization). The assistant accesses the emailbox, reads the email message, and, optionally, responds to its sender. So that the executive can know the present status of this email message, the assistant selects (step 208) a route operation for the email message. As a result, a routing slip is generated (step 212) in the executive's emailbox and the email message is converted (step 216) into an electronic format, e.g., for attachment to the routing slip or for storage in a database, as described above.

The assistant who generated the routing slip can then enter (step 220) information into the routing slip for the executive to read. For example, the assistant can instruct the executive that the email message needs immediate attention or that a response has already been sent to the customer. The instructions written to the routing slip remain separate from the contents of the email message. The assistant does not need to forward the routing slip to the executive because the executive normally accesses the emailbox in which the routing slip resides. Upon accessing (step 220) the emailbox, the executive can view (step 224) the routing slip, read the instructions left by the assistant, and view the contents of the email message by opening the attachment or clicking on the link to retrieve the email message from the database.

The present invention may be implemented as one or more computer-readable software programs embodied on or in one or more articles of manufacture. The article of manufacture can be, for example, any one or combination of a floppy disk, a hard disk, hard-disk drive, a CD-ROM, a DVD-ROM, a flash memory card, an EEPROM, an EPROM, a PROM, a RAM, a ROM, or a magnetic tape. In general, any standard or proprietary, programming or interpretive language can be used to produce the computer-readable software programs. Examples of such languages include C, C++, Pascal, JAVA, BASIC, Visual Basic, and Visual C++. The software programs may be stored on or in one or more articles of manufacture as source code, object code, interpretive code, or executable code.

Although the invention has been shown and described with reference to specific preferred embodiments, it should be understood by those skilled in the art that various changes in form and detail may be made therein without departing from the spirit and scope of the invention as defined by the following claims. For example, although each above-described embodiment describes a member of an organization who deliberately generates a routing slip for a given email message, the organization can develop an automated process that automatically generates a routing slip whenever an email message is received by a particular emailbox, and then automatically routes that routing slip to the emailbox of a designated member of the organization.

What is claimed is:

1. A method for separating an email message from intra-organizational communications used to process that email message, the method comprising:
receiving a first email message by an email client program executing at a client computing system;
selecting a route operation for the first email message; and
generating, in response to selecting the route operation, a second email message having therein an electronic representation of the first email message through which content of the first email message can be accessed by a viewer of the second email message.

2. The method of claim 1, further comprising storing an electronic record corresponding to the first email message in a database in response to the route operation.

3. The method of claim 1, wherein the electronic representation included in the second email message includes a link to the electronic record stored in the database.

4. The method of claim 1, wherein the electronic representation included in the second email message includes a file that is attached to the second email message.

5. The method of claim 1, further comprising selecting an unroute operation for the routing slip to restore the first email message.

6. A computing system, comprising:
a processor;
memory; and
an electronic mail (email) client program stored in the memory and executed by the processor, the email client program receiving a first email message and generating a second email message having therein an electronic representation of the first email message in response to a selection of a route operation for the first email message,
wherein content of the first email message is accessible by a viewer of the second email message through the electronic representation.

7. The computing system of claim 6, further comprising an electronic record corresponding to the first email message for storing in a database in response to the route operation.

8. The computing system of claim 6, wherein the electronic representation included in the second email message includes a link for accessing the electronic record in the database.

9. The computing system of claim 6, wherein the electronic representation included in the second email message includes a file that is attached to the second email message.

10. The computing system of claim 6, wherein the email client program restores the first email message in response to a selection of an unroute operation for the routing slip.

11. An apparatus for separating an email message from intra-organizational communications used to process that email message, the apparatus comprising:
means for receiving a first email message by an email client program executing at a client computing system;
means for selecting a route operation for the first email message; and
means for generating, in response to the selecting of the route operation, a second email message having therein an electronic representation of the first email message through which content of the first email message can be accessed by a viewer of the second email message.

12. The apparatus of claim 11, further comprising means for storing an electronic record corresponding to the first email message in a database in response to the route operation.

13. The apparatus of claim 11, wherein the electronic representation included in the second email message includes a link to the electronic record stored in the database.

14. The apparatus of claim 11, wherein the electronic representation included in the second email message includes a file that is attached to the second email message.

15. The apparatus of claim 11, further comprising means for selecting an unroute operation for the routing slip to restore the first email message.

16. A computer program product for use with a computer system, the computer program product comprising a computer useable medium having embodied therein program code comprising:
program code for receiving a first email message by an email client program executing at a client computing system;
program code for selecting a route operation for the first email message; and
program code for generating, in response to the selecting of the route operation, a second email message having therein an electronic representation of the first email message through which content of the first email message can be accessed by a viewer of the second email message.

17. The computer program product of claim 16, further comprising program code for storing an electronic record corresponding to the first email message in a database in response to the route operation.

18. The computer program product of claim 16, wherein the electronic representation included in the second email message includes a link to the electronic record stored in the database.

19. The computer program product of claim 16, wherein the electronic representation included in the second email message includes a file that is attached to the second email message.

20. The computer program product of claim 16, further comprising program code for selecting an unroute operation for the routing slip to restore the first email message.

21. A computer data signal embodied in a carrier wave for use with a computer system having a display and capable of generating a user interface through which a user may interact with the computer system, the computer data signal comprising:
program code for receiving a first email message by an email client program executing at a client computing system;
program code for selecting a route operation for the first email message; and
program code for generating, in response to the selecting of the route operation, a second email message having therein an electronic representation of the first email message through which content of the first email message can be accessed by a viewer of the second email message.

22. The computer data signal of claim 21, further comprising program code for storing an electronic record corresponding to the first email message in a database in response to the route operation.

23. The computer data signal of claim 21, wherein the electronic representation included in the second email message includes a link to the electronic record stored in the database.

24. The computer data signal of claim 21, wherein the electronic representation included in the second email message includes a file that is attached to the second email message.

25. The computer data signal of claim 21, further comprising program code for selecting an unroute operation for the routing slip to restore the first email message.
